(19) United States
(12) Patent Application Publication
(10) Pub. No.: US 2014/0057677 A1
(43) Pub. Date: Feb. 27, 2014

(54) Tablet or Smart Phone Compatible Fish Finder Device

(71) Applicant: UAB Friday Lab, Vilnius (LT)

(72) Inventors: Aurelijus Liubinas, Vilnius (LT); Rolandas Sereika, Kedainiai (LT)

(73) Assignee: UAB FRIDAY LAB, Vilnius (LT)

(21) Appl. No.: 14/000,947

(22) PCT Filed: Oct. 23, 2012
(86) PCT No.: PCT/IB2012/055817

§ 371 Date: Aug. 22, 2013

(30) Foreign Application Priority Data
Apr. 24, 2012 (LT) 2012-029

(51) Int. Cl. G01S 15/96; H04M 1/02

(52) U.S. Cl. CPC G01S 15/96; H04M 1/026
USPC 455/556.1; 367/87

(57) ABSTRACT

A fish finder system, comprising a sonar gadget, which communicates with a display device via digital wireless communication. The system contains a software product, which runs both on the sonar gadget and the display device, wherein the gadget part of the software is preferably adapted to run on an embedded microcontroller system and the user display device part of the software is preferably a downloadable application adapted to run on portable communication devices, such as smart phones, tablet computers, laptops or the like. Said display device part of the software is adapted not only to visualize the obstacles with indication of depth, size and movement, but also provide additional functionality, such as access to a camera device, digital maps and GPS, social network accounts, weather information and forecast, calendar with notes, information on moon phases and other kinds of information found on the Internet. Both software parts allow update functionality.

### FIELD OF INVENTION

The invention relates to sonar devices. More particularly it relates to fish finder type sonar devices, which are compatible with personal communication devices, such as tablet computers or smart phones.

### BACKGROUND OF INVENTION

Sonar devices are used by fishermen in order to determine fishing conditions in a given fishing place. The conditions include sensing of bottom of a lake, location and size of fishes, water temperature, etc.

Most of the fish finder sonar devices are operated by means of ultra-sound generation and measuring of ultra-sound signals, reflected from obstacles within water. Said reflected and received signals are interpreted and/or immediately transmitted to a display device, having graphical output means, wherein the user can actually see location of fishes, relief of the bed of a water pool, water temperature, etc. Previous patented inventions are known, where the information is transferred between the sonar device and the display device both by means of analogue radio waves or data pocket type digital connection, usually referred to as wireless.

A korean patent No. KR100993227, published on 2010-Nov.-9, describes a fish group finder, provided to three-dimensionally display fish detecting information using various graphical functions. A smart type fish detecting unit is mounted on one side of a ship, or a float shape of the smart type fish detecting unit is installed on the sea. A fish group finding signal is received from a smart phone through wireless communication, a fish group is detected. Information related to the fish group is transmitted to the smart phone. The information is displayed on the screen of the smart phone.

A US patent application No. US2007147173, published on 2007-Jun.-28, describes a detector for fishing, which detects the depth of water, the temperature of water, the distribution of fishes including fishes' migration and/or the length of fishes. The detector includes: a sensor transmitting an ultrasonic signal into the water in a fishing site and receiving a reflective ultrasonic signal reflected from an underwater object; a control unit analyzing/determining the waveform of the reflective ultrasonic signal measured in the sensor to then be indicated on an indication unit including a light emission indicator, a numeric indicator, and a water depth/temperature indicator; a switching unit having an elevating rod whose lower end contacts an activation switch to turn on/off electric power supplied from a power source and in the upper end of which a fishing line engagement hole is formed in which a fishing line is connected with the fishing line engagement hole and the elevating rod is exposed to the outside to then be elastically pressed to be opened and closed according to the pressure of the elevating rod; and a main body on the upper surface of which a light-emission indicator, a numeric indicator, and a water depth/temperature indicator are formed, and in which the sensor, the control unit, and the switching unit are embedded in a sealed manner with a predetermined structure. The detector further includes a transmitter transmitting a signal representing the analyzed/determined result in the form of a predetermined waveform wirelessly; The wireless signal transmitted from the transmitter in the fishing detector is received and displayed using a predetermined program via a predetermined receiver having a display such as a personal portable communications terminal like a mobile telephone.

Prior art inventions describe solutions, where different kinds of communication technologies are used to transfer information between the sonar device and the display device, however prior art inventions do not provide additional functionality, which could significantly improve user experience. Fishermen often use digital cameras to take pictures of their catch, they also use maps to navigate themselves to a certain water pool or to mark a certain fishing place. In addition, prior art inventions do not provide convenient means for sharing pictures of the catch or other details of the fishing place and conditions with other fishermen, friends, member of some other community.

Furthermore, the sonar gadget, which is used as a sensing device usually comprises only single attachment protrusion, for attaching it to a fishing line or other kind of cord. Depending on the position of said protrusion on the exterior of the sonar gadget, it determines if the sonar device can be conveniently used during angling from coast using a fishing rod or for attachment to a boat during trolling. For sonar devices, in order for them to reliably collect information of the surroundings, it is essential to maintain appropriate gadget orientation, so that ultrasound transducer's main working direction would be essentially vertical. That should be maintained also when the gadget is dragged on the surface of water.

Algorithms of interpreting the size and location of obstacles tend to be constantly improved. A company producing fish finder devices can also be involved in constant improvement of the interpretation algorithms. State-of-the-art fish finder devices lack the update functionality, which would allow users of the device to update the software product of the sonar gadget.

### SUMMARY

An object of the present invention is to provide a system, sonar gadget (1) and software product, which altogether alleviate the problems indicated above. In other words, the invention aims at providing a system, which comprises a sonar gadget (1), which communicates with a display device (2) via data pocket exchange communication method, in other words, any conventional digital wireless communication method.

The system contains a software product, which runs both on the sonar gadget (1) and the display device (2), wherein the gadget part of the software is preferably adapted to run on embedded microcontroller system (9) and the user display device part of the software is preferably a downloadable application adapted to run on portable communication devices, such as smart phones, tablet computers, laptops or similar. A possibility to use conventional communication devices, comprising sufficiently big screen for displaying visual information, wherein the communication device can be pre-owned by the user, is considered as an advantage provided by this invention.

Said display device part of the software is adapted not only to visualize the obstacles with indication of depth, size and movement, but also provide additional functionality, such as access to a camera device, digital maps and GPS, social network accounts, weather information and forcast, calendar with notes, information on moon phases and other kinds of information found on the Internet.

The display device comprises output means for visually displaying an interface of the display device part of the software. Said interface comprises areas for displaying surroundings-related information (12), such as bed surface relief (17), depth (13), location of obstacles and fishes (4) and water temperature (16). Furthermore, said software interface comprises at least one area (19) with shortcuts to launch or otherwise interact with other device-characteristic functions, such as camera, maps, calendar, social networking software or internet based data sources, such as weather or moon phase information.

Both software parts are preferably arranged to allow update functionality, wherein the display device part of the software downloads update files from the internet or external data storage, and the display device communicates with the sonar gadget via data pocket exchange communication to update the gadget part of the software. Typically it updates the code of the embedded microcontroller system (9).

Furthermore, said sonar gadget comprises several fastening means (11) for attaching of the fishing line or other kind of cord at a different height with respect to the mass center of said sonar gadget (1).

### DESCRIPTION OF DRAWINGS

In order to better understand the invention, and appreciate its practical applications, the following pictures are provided and referenced hereafter. Figures are given as examples only and in no way limit the scope of the invention.

FIG. 1. illustrates the overall composition of the sonar fish finder system in which the invention can be implemented;

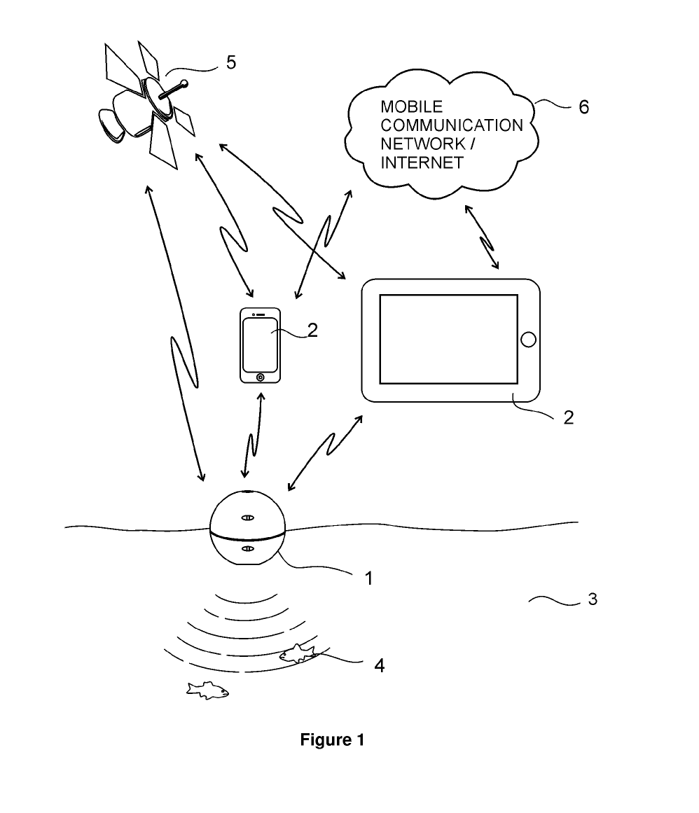

FIG. 2. illustrates the key elements comprised within the sonar gadget (1);

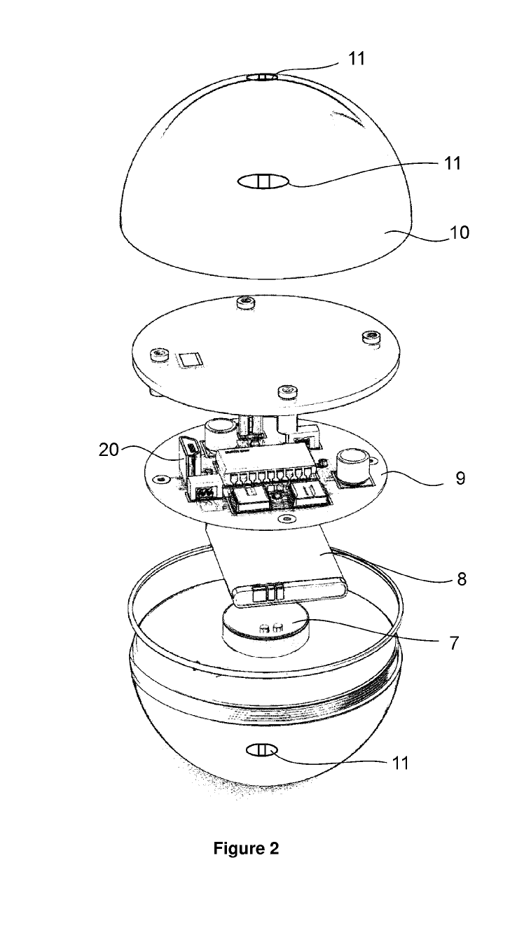

FIG. 3. illustrates typical view of the user interface of the display device (2) software part;

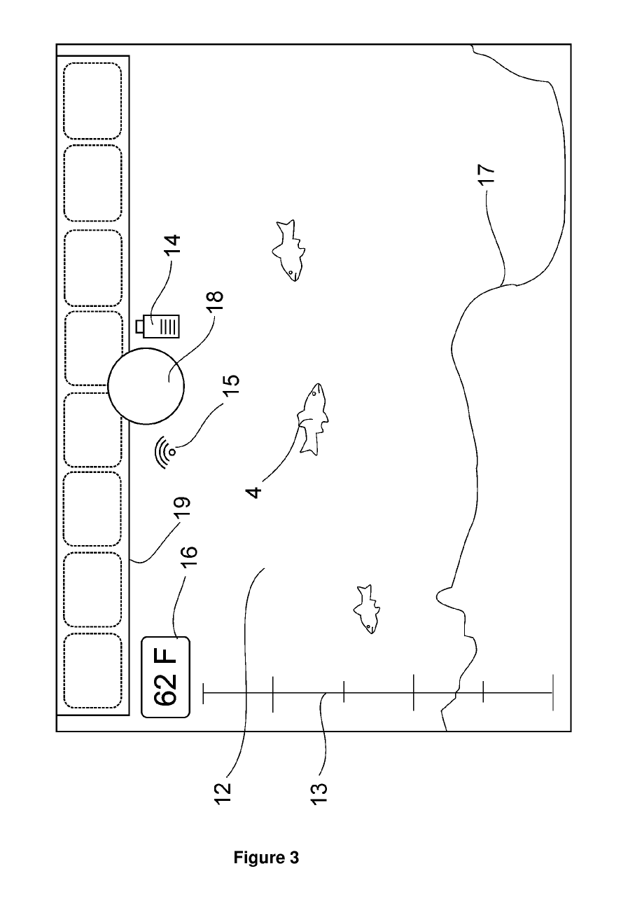

FIG. 4. provides a logical sequence of the software update procedure both in the sonar gadget and the display device.

FIG. 5. provides graphical explanation of steps involved in regular communication between the sonar gadget (1) and the display device (2).

### DETAILED DESCRIPTION OF PREFERRED EMBODIMENTS

Communication methods used to implement this invention can be any conventional digital type communication methods, such as bluetooth, WiFi, 3G, 4G, in which transfer of data pockets is allowed. It should be appreciated, however, that the present invention is not limited to any specific type of data communications, network, protocol or access technology as long as the invention can be implemented.

In the most preferred embodiment, the sonar system for finding and visualizing obstacles in a water pool (3), comprises at least:

1) a sonar gadget (1), which generates ultra-sound signals and receives ultrasound signals as they are reflected from an obstacle;

2) display device (2), arranged to visualize the information received from the sonar gadget (1);

3) software product, which comprises two parts—one being installed in the display device (2), the other being installed in the sonar gadget (1).

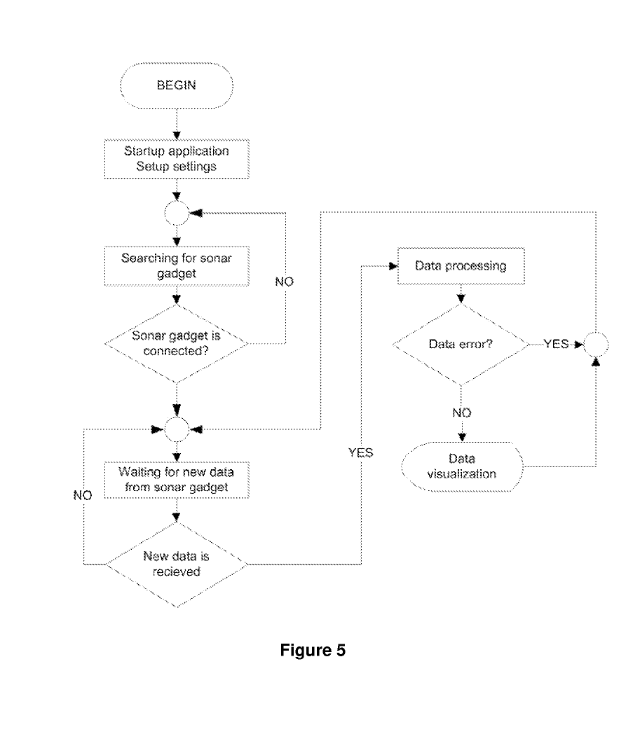

In said fish finder system, the sonar gadget (1) communicates with said display device (2) in a sequence as described in the FIG. 5.

The sonar gadget (1) comprises an ultra-sound generating device (7), preferably made of piezoelectric ceramics. The same ultra-sound device (7) is adapted to receive ultra-sound signals, reflected from obstacles, such as fishes (4), rocks, or similar. Further, the sonar gadget (1) preferably comprises rechargeable battery (8), embedded microcontroller based electronics component (9) and a water tight housing (10). In the most preferred embodiment, two or more fastening means (11) are arranged on the exterior of said housing (10), for attachment of a fishing line or a cord. Said fastening means (11) are located at different height with respect to the mass center of the sonar gadget (1).

Yet in another preferred embodiment, one of the cord fastening means (11) is located at the top of the sonar gadget, whereas other one or more of the cord fastening means (11) are located on the side of the sonar gadget (1). In case the gadget (1) is used from a boat or from a high bridge, the cord is fastened to the fastening means (11) located at the top of the sonar gadget (1). Whether the sonar gadget (1) is used when fishing from a coast and needs to be thrown further away, or it is used in trolling, the cord is fastened to the fastening means (11), located on the side of the sonar gadget (1). The bigger is the distance from the fisherman to the sonar gadget (1), the lower the cord is attached.

Yet in another preferred embodiment, the sonar gadget (1) further comprises a global positioning system (GPS) receiver inside the water tight housing (10). Such arrangement provides capability of assigning global position data to the surroundings information, as detected by the sonar gadget (1), thus providing building blocks for complete maps of beds (17) of water pools (3).

Yet in another preferred embodiment, the water pool (3) bed (17) maps are combined with average or statistical values of the water temperature (16), depth information (13) and average values of fish (4) appearance in certain places of a water pool (3).

In the most preferred embodiment, the software part, which is installed in the display device (2) comprises a graphical user interface, which provides information related to fishing environment (12). It provides one or more of bed surface relief (17), depth (13), location of obstacles and fishes (4), movement of fishes (4) and water temperature (16).

Yet in another preferred embodiment, said software interface comprises an area (19) with shortcuts to launch or otherwise interact with device-characteristic functions, such as camera, maps, calendar, social networking software or internet based data sources, such as weather- or moon phase information. These device-characteristic functions can be either as a part of the fish finder system software or as individual pieces of software previously installed or separately downloaded and installed in the display device (2).

Yet in another preferred embodiment, the device-characteristic social networking functions are arranged either as software applications (apps) provided by the social network account providers or shortcuts to an internet based data source, comprising user login details. Social networking functionality is used to instantly share pictures, messages or location indications with friends, family or other community members, such as other fishermen or the like.

Yet in another preferred embodiment, the two parts of the fish finder system software are arranged so, that the sonar gadget (1) software component is pre-installed in the gadget (1) as a part of the manufacturing processes, whereas the display device (2) software component is downloaded and installed in the display device (2) by the user him/herself. It can be arranged as an app (mobile application), which can be purchased or downloaded for free from an independent e-shop or from special app store operated by the display device manufacturer or the like. Said display device software component can be also provided as pre-installed application if the display device (2) is provided together with the sonar gadget (1)—as a complete system.

Yet in another preferred embodiment, the map and GPS functionality is used for finding a water pool (3) in the map, navigating to it, bookmarking a fishing spot and assigning visual, verbal or other kind of information to the bookmark.

Yet in another preferred embodiment, the device-characteristic camera functionality is arranged as a native (pre-installed in the display device (2)) software application used for taking pictures or video of the catch or some elements of the fishing environment. Created visual content can be readily shared with community members using the social networking functionality, as described above.

Yet in another preferred embodiment, the display device part of the software comprises input means for capturing a screenshot of the display device (2). Said screenshots can be stored or shared with community members through the same social networking functionality.

Yet in another preferred embodiment, the display device (2) can be connected to another sonar, i.e. it is not necessarily associated just with a single sonar gadget (1). In such embodiment, several sonar devices could be used in bigger area of a water pool and a fisherman could easily monitor several locations remotely using a single display device (2).

Yet in another preferred embodiment, the sonar gadget (1) comprises a conventional connector (20), which allows charging of the battery (8) and/or wired data communication. Using said connector (20), the code of the embedded microprocessor electronics component (9) within the sonar gadget (1) could be updated. The connector could be micro-USB or any other conventional type to suit the purposes of battery recharge and/or data transfer.

Yet in another preferred embodiment, the graphical user interface, which is displayed on the display device (2) comprises indicators of at least one of the sonar gadget (1) parameters, such as battery level (14), strength and/or of wireless connection (15), strength or state of GPS (5) connection.

Yet in another preferred embodiment, the graphical user interface, which is displayed on the display device (2) comprises input means (18) for showing or hiding the area (19) containing shortcuts to launch or otherwise interact with device-characteristic functions.

Yet in another preferred embodiment, the water tight housing (10) of the sonar gadget (1) comprises two electrodes, which are separated from each other and arranged to act as an activation sensor. Whenever the gadget (1) is thrown into water, small amount of current starts to flow between the two electrodes, through the water and the device is tuned on. Such arrangement allows saving battery power, if the gadget (1) is often displaced by removing it from water.

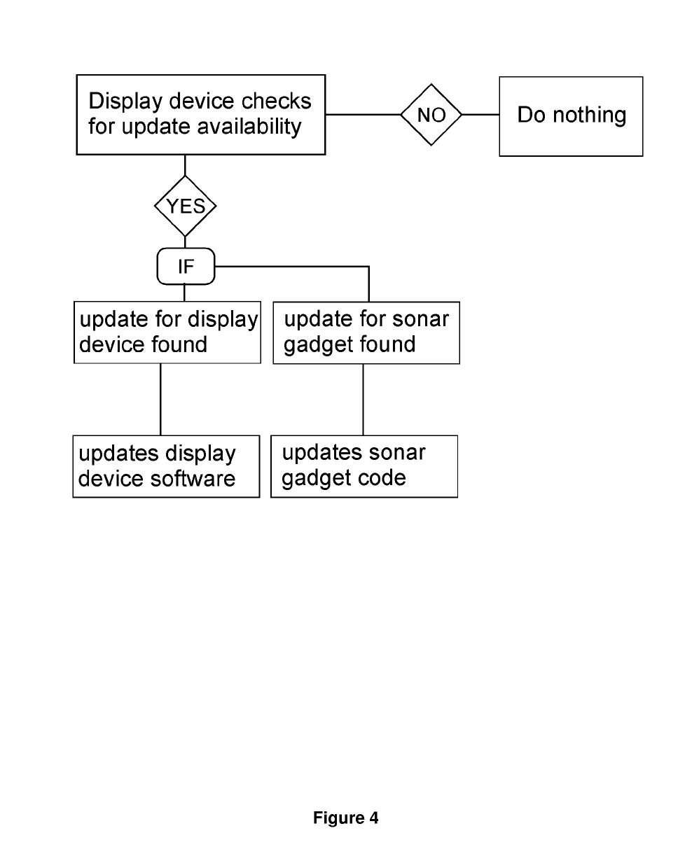

Yet in another preferred embodiment, the software product, installed both on the sonar gadget (1) or the display device ( ) is provided with update functionality. FIG. 4 explains, how the software updates are found and installed on the sonar gadget (1) and the display device (2). The updates can be downloaded from the Internet or transferred from an external memory. The code update is transferred to the sonar gadget (1) either wirelessly or via a data cable, such as USB or other conventional type.

1. A fish finder system, comprising:
a sonar gadget comprising an ultrasound scanning device; and
a display device comprising output means for visually displaying at least an area of information related to a fishing environment, wherein said display device further comprises at least one of:
an input means for activating or interacting with a display device-characteristic function and
an output means for displaying information relating to the sonar gadget.

2. The fish finder system according to claim 1, wherein said display device-characteristic function comprises one or more of a camera, a map, a UPS, a calendar, weather information, moon phase information, and social networking.

3. The fish finder system according to claim 1, wherein said output means for displaying information relating to the sonar gadget comprises at least one of a battery level indicator, a wireless connection strength or state indicator, and a GPS connection state and strength indicator.

4. The fish finder system according to claim 1, wherein said sonar gadget further comprises a connector for data transfer and charging of a battery.

5. The fish finder system according to claim 1, further comprising at least one of a wireless and a wired communication link between the display device and the sonar gadget, and wherein the at least one of the wireless and the wired communication link is arranged to provide bidirectional communication.

6. The fish finder system according to claim 5, wherein the sonar gadget is arranged to receive software code updates by means of the at least one of the wired and the wireless communication link from at least one of the display device, an external data storage, and an internet data source.

7. The fish finder system according to claim 1, wherein the display device is arranged to connect to multiple sonar gadgets.

8. A sonar gadget device, comprising an active element for ultrasound generation and reception, wherein the sonar gadget device further comprises a water tight housing comprising fastening means for attachment of a cord or a fishing line.

9. The sonar gadget according to claim 8, wherein a first portion of the fastening means is arranged at a top of said water tight housing and a second portion of the fastening means is arranged on a side of the water tight housing.

10. The sonar gadget according to claim 8, wherein that the sonar gadget comprises two electrodes, located on a surface of the water tight housing, wherein the two electrodes are separated from each other and arranged to act as an activation sensor, and wherein said activation sensor is activated when the sonar gadget is placed into water.

11. A software product arranged to be installed on a fish finder system, wherein the software product comprises at least two parts, a display device part arranged to run on a conventional display device, and a sonar gadget part that is arranged to be installed on a sonar gadget.

12. The software product according to claim 11, wherein said at least two parts of the software product are provided with an update functionality, such that update data is transferrable to the fish finder system from at least one of an Internet and an external memory device.

13. The fish finder system according to claim 1, further comprising a wireless communication link between the display device and the sonar gadget, and wherein the wireless communication link is arranged to provide bidirectional communication between the display device and the sonar gadget.

14. The fish finder system according to claim 2, wherein the output means for displaying information relating to the sonar gadget comprises one or more of a battery level indicator, a wireless connection strength or state indicator, and a UPS connection state or strength indicator.

15. The fish finder system according to claim 2, wherein the sonar gadget further comprises a connector for data transfer and charging of a battery.

16. The fish finder system according to claim 6, wherein the sonar gadget is configured to communicate the area of information related to the fishing environment to the display device wirelessly.

17. The fish finder system according to claim I, wherein the display device is configured to communicate with multiple sonar gadgets.

18. The sonar gadget according to claim 9, wherein the sonar gadget comprises two electrodes, located on a surface of the water tight housing, wherein the two electrodes are separated from each other and arranged to act as an activation sensor, and wherein said activation sensor is activated when the sonar gadget is placed into water.

19. The software product of claim 11, wherein the conventional display device is selected from a tablet computer, a smart phone, and a laptop computer.

20. The software product of claim 11, wherein the display device part of the software product is configured to display surroundings-related information on the display device.
